(19) United States
(12) Patent Application Publication
(10) Pub. No.: US 2010/0160151 A1
(43) Pub. Date: Jun. 24, 2010

(54) Method for manufacturing ammonia gas absorbent using Fe-zeolite

(75) Inventors: In Kook Bae, Daejeon (KR); Young Nam Jang, Daejeon (KR); Soo Chun Chae, Seoul (KR); Sung Ki Lee, Daejeon (KR); Kyeoung Won Ryu, Daejeon (KR)

Correspondence Address: GWIPS;Peter T. Kwon, Gwacheon P.O. Box 72, 119 Byeolyang Ro, Gwacheon City, Gyeonggi-Do, 427-600, KR

(73) Assignee: Korea Institute of Geoscience and Mineral Resource

(21) Appl. No.: 12/461,034

(22) Filed: Jul. 30, 2009

(30) Foreign Application Priority Data
Jul. 31, 2008 (KR) 10-2008-0075362
Jul. 9, 2009 (KR) 10-2009-0062744

(51) Int. Cl. B01J 29/88

(52) U.S. Cl. 502/74

(57) ABSTRACT

A method is developed for fabrication of an ammonia gas adsorbent using Fe-zeolite. This method uses Fe-zeolite obtained from municipal waste slag to prepare a gas adsorbent, thereby reusing molten slag as a specified waste so as to improve the value of the waste. To achieve the purpose, the method includes mixing Fe-zeolite powder with a forming adjuvant to prepare a mixture; adding a forming agent to the mixture to obtain a granular Fe-zeolite product; and drying and calcining the obtained granular Fe-zeolite product. Therefore, Fe-zeolite obtained from molten slag as a waste product can be reused as an ammonia gas adsorbent.

### BACKGROUND OF THE INVENTION

1. Field of the Invention

The present invention relates to a method for manufacturing an ammonia gas absorbent using Fe-zeolite and, more particularly, a method for fabrication of an ammonia gas absorbent capable of adsorbing and removing hazardous ammonia gas using Fe-zeolite, which includes forming Fe-zeolite starting from molten slag of municipal waste into a granular shape and activating the formed material.

2. Description of the Related Art

With rapid growth and industrialization of modern society, a great quantity of pollutants such as domestic and/or municipal waste is generated and discharged into the environment. However, direct disposal of such pollutants requires increase of landfill area and causes discharge of heavy metals, thus entailing some environmental problems that cause secondary pollution to ecological circumstances such as rivers, mountains and forests, the atmosphere, and so forth.

Accordingly, in order to prevent the foregoing problems, Japan and other advanced countries generally adopt melting processes for incinerated ashes at 1,300° C. to reduce waste volume as well as incineration processes.

Molten slag obtained through the melting process contains abundant SiO₂ and Al₂O₃ and may be considered a suitable material for synthesis of zeolite, which has drawn the most attention as an environment-improving agent. Zeolite is well known to have pores with a constant size and is used in various industrial applications, for example, as a catalyst, a laundry detergent builder, and the like.

Additionally, a great deal of studies and investigations into improvement of catalytic characteristics and/or adsorptive properties of zeolite by transferring cations contained in the zeolite into metal cations are currently being conducted.

Owing to industrialization, air pollutants generated in households, factories, automobiles and/or power plants have varied and increased so that interest in toxic airborne pollutants is also increasing. Especially, the most common hazardous gases emitted by sewage and night soil treatment plants are hydrogen sulfide and ammonia. For removal of such gases, activated carbon and zeolite have been developed and widely used.

However, these materials encounter a problem of reduced lifespan due to limited adsorption performance. Therefore, there is still a requirement for development of alternative gas phase adsorbents to overcome the foregoing problem.

### SUMMARY OF THE INVENTION

Therefore, the present invention is directed to solve the above problems and it is an object of the present invention to provide a method for fabrication of an ammonia gas adsorbent using Fe-zeolite, which uses Fe-zeolite obtained from molten slag as a specified waste generated during a melting process of incinerated ashes of domestic waste in order to adsorb and remove hazardous ammonia gas and which reuses the molten slag as an atmosphere-improving agent in order to stably treat waste and, in addition, to improve the value of the waste.

In accordance with the present invention, the above and other objects can be accomplished by the provision of a method for fabrication of an ammonia gas adsorbent using Fe-zeoliate, which includes mixing Fe-zeolite powder with a forming adjuvant to prepare a mixture, adding a forming agent to the mixture to obtain a granular Fe-zeolite product, and drying and calcining the obtained granular Fe-zeolite product.

The calcining process may be performed at 450° C. to 550° C. and the mixing process may be carried out using a vertical granulator.

The Fe-zeolite powder is prepared by reforming (or modifying) zeolite Na-A obtained from molten slag with an Fe compound, wherein the Fe compound contains 2.5 wt. to 3.5 wt. parts of Fe relative to 100 wt. parts of zeolite Na-A.

As described above, the inventive method for fabrication of an ammonia gas adsorbent using Fe-zeolite uses molten slag obtained from domestic and/or municipal waste as a starting material to prepare the gas adsorbent capable of adsorbing and removing hazardous gases. As a result, molten slag known as a specified waste may be recycled as an atmosphere-improving agent, while enabling fabrication of an adsorbent for hazardous ammonia gas by environmentally friendly processes as well as stable disposal of waste.

In addition, the present invention has advantages in that the produced adsorbent is applicable to incinerated ashes and/or molten materials of municipal waste or sewage, as well as those of specified wastes containing SiO₂ and Al₂O₃ as major ingredients, so as to prevent environmental pollution and the incinerated ashes and/or molten materials may be recycled.

Moreover, compared to conventional manufacturing processes, the inventive method uses solid substances as raw materials, such as water glass (that is, sodium silicate) and polyvinyl alcohol (PVA) possibly taken from molten materials and/or incinerated ashes of municipal waste or sewage sludge, thereby manufacturing the gas adsorbent at reduced production cost while improving production efficiency thereof.

### BRIEF DESCRIPTION OF THE DRAWINGS

FIG. 1a is a flow chart illustrating a conventional process of preparing Fe-zeolite from molten slag, which is further used for the present invention.

FIG. 1b is a flow chart illustrating a method for fabrication of an ammonia gas adsorbent using Fe-zeolite according to the present invention.

FIG. 2 shows a hazardous ammonia gas adsorption apparatus.

FIG. 3 shows XRD patterns of Fe-zeolite depending on Fe content.

FIG. 4 is a graph illustrating change in BET specific surface area of Fe-zeolite depending on Fe content.

FIG. 5 is a graph illustrating hazardous ammonia gas adsorption capacity (%) depending on calcination temperatures. and

FIG. 6 is a graph illustrating hazardous ammonia gas adsorption capacity (%) depending on Fe content.

### DETAILED DESCRIPTION OF THE PREFERRED EMBODIMENTS

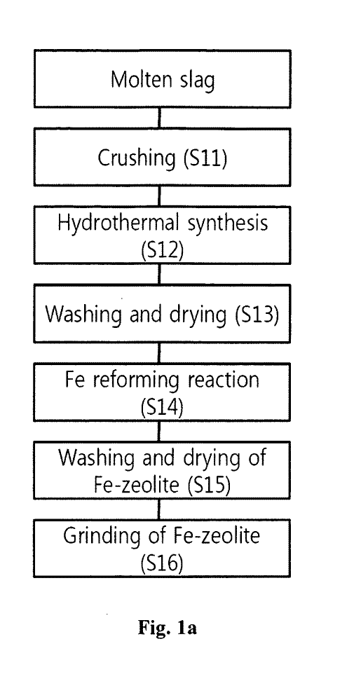

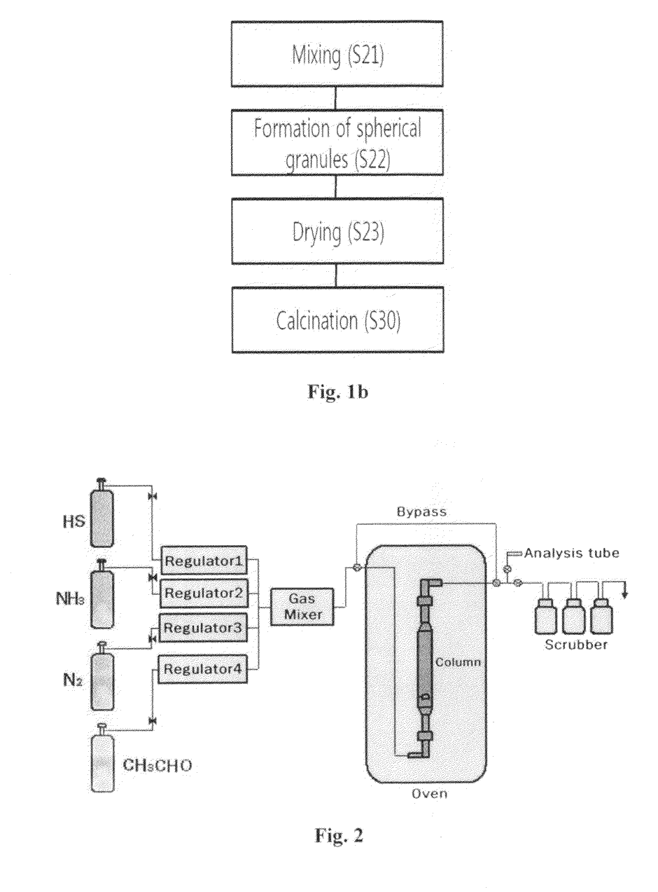

FIG. 1a a flow chart illustrating a conventional process of preparing Fe-zeolite from molten slag, which is further used in the present invention, and FIG. 1b is a flow chart illustrating a method for fabrication of an ammonia gas adsorbent using Fe-zeolite according to the present invention.

Referring to FIG. 1a, Fe-zeolite is obtained by a method comprising: a slag grinding process S11 of drying molten slag obtained from municipal waste at 80° C. to 110° C. for 24 hours, crushing the dried slag by means of a ball-mill, and grinding the crushed slag into small particles with a size of not more than 200 mesh; a hydrothermal synthesis process S12 of mixing the ground slag obtained from the process S11 with a sodium silicate solution and a sodium aluminate solution, and then, heating the mixture at 60° C. to 100° C. for 8 hours under stirring to form zeolite Na-A; a washing and drying process S13 of cooling the zeolite Na-A obtained from the process S12 at 15° C. to 40° C., washing the cold product to have pH 11 to 13 and drying the washed product; an Fe reforming process S14 of adding the dried zeolite Na-A obtained from the process S13 to an Fe compound such as FeCl₃.6H₂O in water to reform the solution at 15° C. to 40° C.; a washing and drying process S15 of washing the reformed Fe-zeolite obtained from the process S14 by means of a filter press and drying the washed product; and an Fe-zeolite grinding process S16 of grinding the Fe-zeolite obtained from the process S15 into small particles having a size of not more than 100 mesh.

Referring to FIG. 1b, the method for fabrication of an ammonia gas adsorbent comprises in general: a process of mixing molten slag as a starting material with Fe-zeolite powder and a forming adjuvant to produce a mixture S21; a process of adding a forming agent to the mixture to prepare a granular product S22; and a process of drying S23 and calcining S30 the granular product obtained from the process S22, wherein a temperature of the calcining process S30 ranges from 450° C. to 550° C., the forming adjuvant comprises bentonite and the forming agent comprises at least one of water glass and PVA. An amount of bentonite may range from 5 wt. to 15 wt. parts relative to 100 wt. parts of Fe-zeolite powder, an amount of water glass as a binder may range from 5 wt. to 15 wt: parts to 100 wt. parts of Fe-zeolite powder, and an amount of PVA as a binder may range from 1.5 wt. to 4 wt. parts to 100 wt. parts of Fe-zeolite powder. Moreover, the Fe-zeolite powder is mixed with the forming adjuvant using a vertical granulator. The Fe-zeolite is obtained by reforming zeolite Na-A contained in molten slag with a Fe compound. The Fe compound contains 2.5 wt. to 3.5 wt. parts of Fe ingredient to 100 wt. parts of the zeolite Na-A. The zeolite Na-A is obtained by reaction of molten slag with liquid sodium silicate and liquid sodium aluminate. If such amount of each of bentonite, sodium silicate and PVA is below a lower limit, the material cannot function as the forming adjuvant and/or the forming agent. On the other hand, even when the amount of the material exceeds an upper limit, the material does not exhibit improved effects while causing an increase in production costs.

Large amounts of molten slag, which has in general not been utilized for any specific purpose, are generated in processes of incinerating and/or melting municipal waste. However, the dried slag is grinding to be fine powder having a size of less than 200 meshes and mixing the powder with liquid sodium silicate and liquid sodium aluminates to be enable molten slag having useful performances. More particularly, zeolite obtained by mixing molten slag with liquid sodium silicate and liquid sodium aluminate may have adsorption ability. However, zeolite itself has some restrictions in use as an ammonia gas adsorbent and, in order to overcome such restrictions, the zeolite may be reformed or changed into granular form. The granular form may be a spherical shape.

As disclosed above, the present invention adopts a simple process of using Fe metal ions to reform zeolite obtained from molten slag, thereby effectively reducing production costs by eliminating use of high purity chemicals. Therefore, the present invention may enable development of Fe-zeolite with economic benefits and excellent performance of adsorbing ammonia gas.

Hereinafter, a detailed description will be given of constructional functions and advantages of the present invention with reference to the following examples and comparative examples.

### Example 1

As shown in FIG. 1a, molten slag was mixed and reacted with liquid sodium silicate and liquid aluminate (NaAlO₂) to prepare Fe-zeoliate. A ratio of Na₂O to Al₂O₃ (Na₂O:Al₂O₃) in sodium aluminate was 1.2:1 and the reaction was performed in a hydrothermal container at 80° C. for 10 hours. 2,500 g of the prepared zeolite Na-A was placed in a solution of FeCl₃.6H₂O in 25 liters of water and was subjected to a reforming reaction at room temperature over 24 hours under stirring. Fe content of FeCl₃.6H₂O was 1 wt. to 4 wt. parts to 100 wt. parts of zeolite Na-A. Next, the reformed product was washed three times using a filter press and was dried at 90° C. for 24 hours to produce Fe-zeolite.

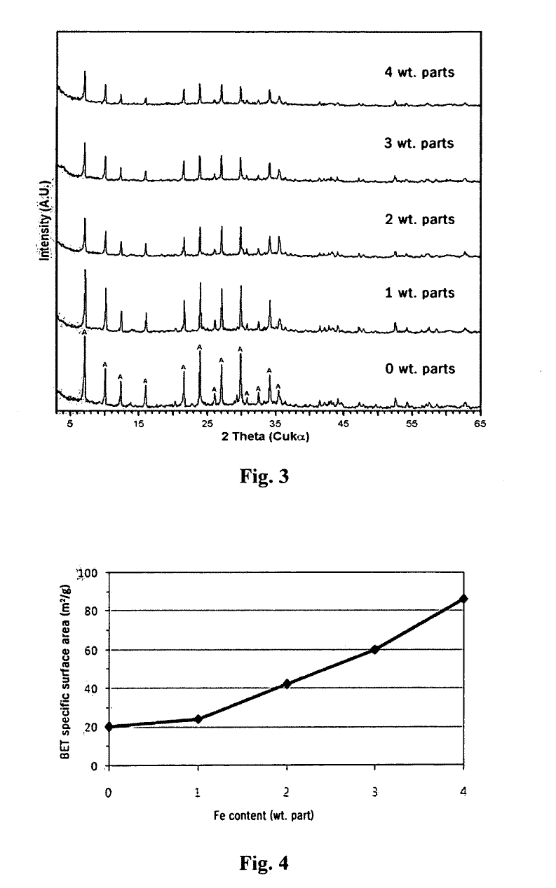

FIG. 2 shows a hazardous ammonia gas adsorption apparatus, FIG. 3 shows XRD patterns of Fe-zeolite depending on Fe content, and FIG. 4 is a graph illustrating change in BET specific surface area of Fe-zeolite depending on Fe content.

Referring to FIG. 3, zeolites reformed using 1 wt. to 4 wt. parts of Fe show typical XRD patterns of zeolite Na-A. As shown in FIG. 4 illustrating measured results of BET specific surface area as an important factor relating to gas adsorption, the zeolite Na-A has a BET specific surface area of about 20 m2/g. On the other hand, the Fe-zeolite has a BET specific surface area increasing in relation to Fe content in parts by weight, especially, a maximum BET specific surface area of 85 m2/g at 4 wt. parts of Fe content.

### Example 2

In order to endow functional performances to the Fe-zeolite prepared in Example 1, bentonite as a forming adjuvant was added to a dried powder mixture comprising Fe-zeolite. More particularly, 10 wt. parts of bentonite were added to 100 wt. parts of Fe-zeolite powder mixture, followed by blending the same in a vertical granulator for 10 minutes. 10 wt. parts of water glass as a binder were sprayed over 100 wt. parts of Fe-zeolite powder mixture in the vertical granulator so as to form a granular material. The granular material was dried at 100° C. to complete a granular Fe-zeolite product.

### Example 3

In order to endow functional performances to the Fe-zeolite prepared in Example 1, bentonite as a forming adjuvant was added to a dried powder mixture comprising Fe-zeolite. More particularly, 10 wt. parts of bentonite were added to 100 wt. parts of Fe-zeolite powder mixture, followed by blending the same in a vertical granulator for 10 minutes. 2.5 wt. parts of PVA as a binder was sprayed over 100 wt. parts of Fe-zeolite powder mixture in the vertical granulator so as to form a granular material. The granular material was dried at 100° C. to complete a granular Fe-zeolite product.

### Example 4

As for the granular Fe-zeolites formed using 10 wt. parts of water glass and 2.5 wt. parts of PVA, respectively, according to Examples 2 and 3, each of the granular Fe-zeolites was calcined at different temperatures, so as to enhance strength of Fe-zeolite and to activate the same. Physical properties of the produced Fe-zeolite were investigated and compared. More particularly, the granular Fe-zeolite was subjected to calcination at different temperatures ranging from 100° C. to 700° C. and at an interval of 100° C. for 5 hours. A sample used for a gas adsorption test had a particle size of 30 to 80 meshes and a gas adsorption test device is shown in FIG. 2. Evaluation of ammonia gas adsorptive characteristics was performed by sampling 5 g of granular Fe-zeolite, which was formed using water glass or PVA, placing the sample in a column, and drying the sample in a dryer at 30° C. For the sample, gas adsorption capacity was calculated by measuring a content of exhaust gas in a probe type gas concentration detector (Gastec Co.) at one-minute intervals and determining a time at which the content reaches to a break-point (500 ppm). The break-point was determined when a concentration of inflow gas exceeded 10%, that is, when an elimination rate of hazardous gas reached 90%.

Equation for measurement of gas adsorption capacity:

Gas adsorption capacity(%)={adsorbed amount of hazardous gas at break-point(g)/weight of sample before adsorption(g)}×100

Adsorbed amount of hazardous gas at break-point(g)=flow rate of hazardous gas(ml/min)×(molecular weight of hazardous gas/22.414 L)×break time(min)×(concentration of hazardous gas(%)/100)

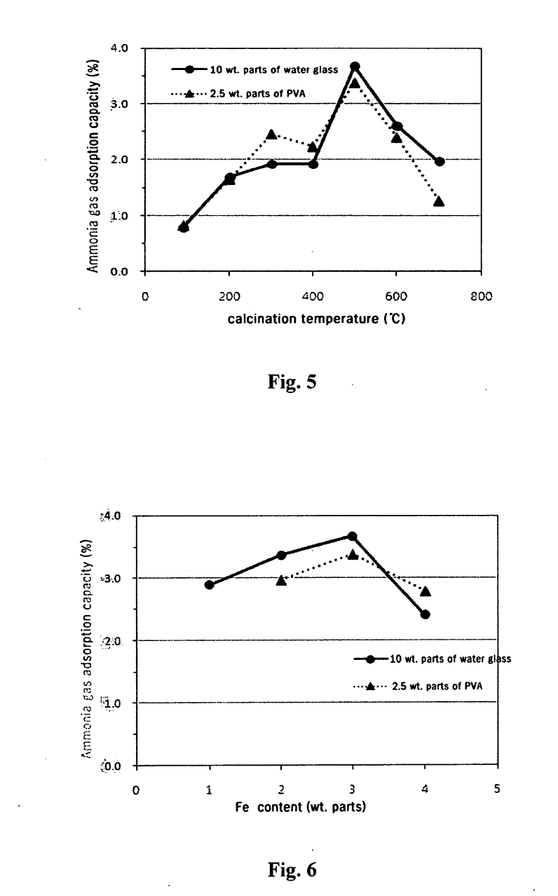

For the granular zeolite calcined at each temperature, results of the evaluated ammonia gas adsorptive characteristics are shown in FIG. 5. As for adsorption capacity depending on calcination temperature, the granular zeolite had the highest adsorption capacity at 500° C. Also, the zeolite with use of water glass as a binder showed a hazardous ammonia gas adsorption capacity of 3.7% a little higher that 3.4% when using PVA as a binder. Consequently, it was understood that the preferable calcination temperature may range from 450° C. to 550° C.

### Example 5

As for the granular Fe-zeolites formed using 10 wt. parts of water glass and 2.5 wt. parts of PVA, respectively, according to Examples 2 and 3, each of the granular Fe-zeolites was calcined at 500° C. for about 5 hours, so as to enhance strength of Fe-zeolite and to activate the same. For the granular zeolite calcined depending on Fe content, results of the evaluated adsorptive characteristics to ammonia gas are shown in FIG. 6. As shown in FIG. 6, the granular zeolite reformed with Fe content of 3 wt. parts had the highest adsorption capacity of 3.7%. Consequently, it was understood that a preferable amount of Fe compound may induce Fe content of 2.5 to 3.5 wt. parts to 100 wt. parts of zeolite Na-A.

TABLE 1
comparison of hazardous ammonia gas adsorption
capacities between different adsorbents

| Sample name | NH₃ adsorption capacity (%) |
|---|---|
| Coconut activated carbon | 0.15 |
| Coal based activated carbon | 0.25 |
| Bamboo activated carbon | 0.44 |
| Zeolite 4A | 0.3-0.6 |
| Zeolite 13X | 0.23 |
| Fe zeolite | 3.7 |

### Comparative Example

Results of hazardous gas adsorption using different adsorbents were proposed in the foregoing TABLE 1. From the results, Fe zeolite exhibited hazardous gas adsorption capacity at least several times higher than other control samples, thereby efficiently functioning as an improved adsorbent to ammonia gas.

Although exemplary embodiments of the present invention has been disclosed for illustrative purposes, those skilled in the art will appreciate that various modifications, additions and substitutions are possible, without departing from the scope and spirit of the invention as disclosed in the appended claims.

What is claimed is:

1. A method for fabrication of an ammonia gas adsorbent using Fe-zeolite, the method comprising steps of:
mixing Fe-zeolite powder with a forming adjuvant to prepare a mixture;
adding a forming agent to the mixture to obtain a granular Fe-zeolite product; and
drying and calcining the obtained granular Fe-zeolite product.

2. The method according to claim 1, wherein a temperature of the calcining process is in range between 450° C. to 550° C.

3. The method according to claim 1, wherein said mixing process is performed using a vertical granulator.

4. The method according to claim 1, wherein said Fe-zeolite powder is prepared by reforming zeolite Na-A contained in molten slag with a Fe compound.

5. The method according to claim 4, wherein said Fe compound contains 2.5 wt. to 3.5 wt. parts of Fe relative to 100 wt. parts of the zeolite Na-A.
